(19) United States
(12) Patent Application Publication
(10) Pub. No.: US 2016/0145833 A1
(43) Pub. Date: May 26, 2016

(54) SYSTEM AND METHOD FOR CONTROLLING POWER IN MACHINE HAVING HYDRAULIC DEVICES

(71) Applicant: CATERPILLAR GLOBAL MINING LLC, Oak Creek, WI (US)

(72) Inventors: Omar Jawdat Abdel-Baqi, Oak Creek, WI (US); Peter J. Miller, Brookfield, WI (US)

(73) Assignee: CATERPILLAR GLOBAL MINING LLC, Oak Creek, WI (US)

(21) Appl. No.: 14/549,765

(22) Filed: Nov. 21, 2014

(51) Int. Cl. E02F 9/22; H02P 25/08

(52) U.S. Cl. CPC E02F 9/2217; H02P 25/085

(57) ABSTRACT

A power control system is disclosed for a machine. The system has an electric motor device configured to power a hydraulic device. The system also has an energy storage device configured to store electrical energy. The system also has an electric driving circuit coupled to the electric motor device and the energy storage device. The electric driving circuit is configured to drive the electric motor device using the electrical energy stored in the energy storage device. The electric motor device is configured to function as a generator to receive power feedback from the hydraulic device and electrically charge the energy storage device through the electric driving circuit.

### TECHNICAL FIELD

The present disclosure relates generally to a system and method for controlling power in a machine having hydraulic devices, and more particularly, to a system and method for controlling power output to and/or feedback from hydraulic devices using electric motor devices and energy storage devices.

### BACKGROUND

Some conventional machines have a hydraulic power source for operating hydraulic actuators. For example, such a machine might typically include one or more internal combustion engines for driving one or more hydraulic pumps, which, in turn, supply power to one or more hydraulic actuators for performing work. One example of such a machine is a hydraulic excavator. A hydraulic excavator may typically include one or more hydraulic pumps, which provide hydraulic power in the form of pressurized fluid flow to one or more hydraulic motors and hydraulic cylinders for operation of a boom, stick, and digging implement. In such a machine, the hydraulic motors may be used to rotate a cab relative to a chassis on which the cab is mounted and drive grounding engaging wheels or tracks for movement of the machine. Hydraulic power provided to the hydraulic actuators may be used to raise and lower the boom and manipulate the stick and the digging implement in order to perform digging and/or loading operations.

To meet the peak power demanded by the hydraulic excavator, two internal combustion engines are normally used to drive the one or more hydraulic pumps. The total available power is normally 30-40% higher than what the hydraulic excavator requires. This additional available power is not used by the hydraulic excavator. In addition, in operation, the hydraulic excavator normally regenerates about 15% of the total machine energy. The regenerative energy is currently being wasted as heat because the internal combustion engines do not recapture and reuse this energy.

To increase the efficiency and/or reduce undesirable emissions resulting from operation of the internal combustion engines, efforts have been made to recapture some of the regenerative energy typically lost during operation of such a machine. For example, energy may be recaptured in the form of electrical energy for use by electric devices. U.S. Pat. No. 7,318,580 B2 to Johnston et al. (“the '580 patent”) discloses an electric driving system for driving a heavy duty wheeled vehicle. In particular, the '580 patent discloses two converters in a back to back configuration, in which one converter is used as a motor drive and the other converter is used as a rectifier. However, such back to back configuration requires two converters, increasing the cost and complexity of the driving system. Therefore, it may be desirable to provide a system and method capable of recapturing regenerative energy with lower cost, higher energy density, and a smaller foot print. The disclosed system and method is directed to providing one or more of these desired advantages.

### SUMMARY OF THE INVENTION

In one aspect, the present disclosure is directed to a power control system for a machine. The power control system includes an electric motor device configured to power a hydraulic device. The power control system also includes an energy storage device configured to store electrical energy. In addition, the power control system includes an electric driving circuit coupled to the electric motor device and the energy storage device. The electric driving circuit is configured to drive the electric motor device using the electrical energy stored in the energy storage device. Moreover, the electric motor device is configured to function as a generator to receive power feedback from the hydraulic device and electrically charge the energy storage device through the electric driving circuit.

In another aspect, the present disclosure is directed to a method of controlling power for a machine. The method includes storing electrical energy in an energy storage device and utilizing an electric driving circuit to drive an electric motor device using the stored electrical energy. The method also includes utilizing the electric motor device to power a hydraulic device. In addition, the method includes receiving power feedback from the hydraulic device and utilizing the electric motor device to generate an electrical charging energy using the power feedback from the hydraulic device. Moreover, the method includes utilizing the electric driving circuit to charge the energy storage device using the electrical charging energy.

In a further aspect, the present disclosure is directed to a machine. The machine includes a chassis and a hydraulic device coupled to the chassis. The machine also includes an electric motor device configured to power a hydraulic device. The machine also includes an energy storage device configured to store electrical energy. In addition, the machine includes an electric driving circuit coupled to the electric motor device and the energy storage device. The electric driving circuit is configured to drive the electric motor device using the electrical energy stored in the energy storage device. Moreover, the electric motor device is configured to function as a generator to receive power feedback from the hydraulic device and electrically charge the energy storage device through the electric driving circuit.

### BRIEF DESCRIPTION OF THE DRAWINGS

FIG. 1 is a schematic perspective view of an exemplary embodiment of a machine including an exemplary embodiment of a power control system for the machine;

FIG. 2 is a schematic diagram of a first embodiment of the power control system for the machine of FIG. 1;

FIG. 3 is a schematic diagram of a second embodiment of the power control system for the machine of FIG. 1;

FIG. 4 is a schematic diagram of a third embodiment of the power control system for the machine of FIG. 1;

FIG. 5 is a circuit diagram of an exemplary embodiment of the power control system for the machine of FIG. 1; and

FIG. 6 is a flow diagram of an exemplary embodiment of a method for controlling power in an exemplary machine.

### DETAILED DESCRIPTION

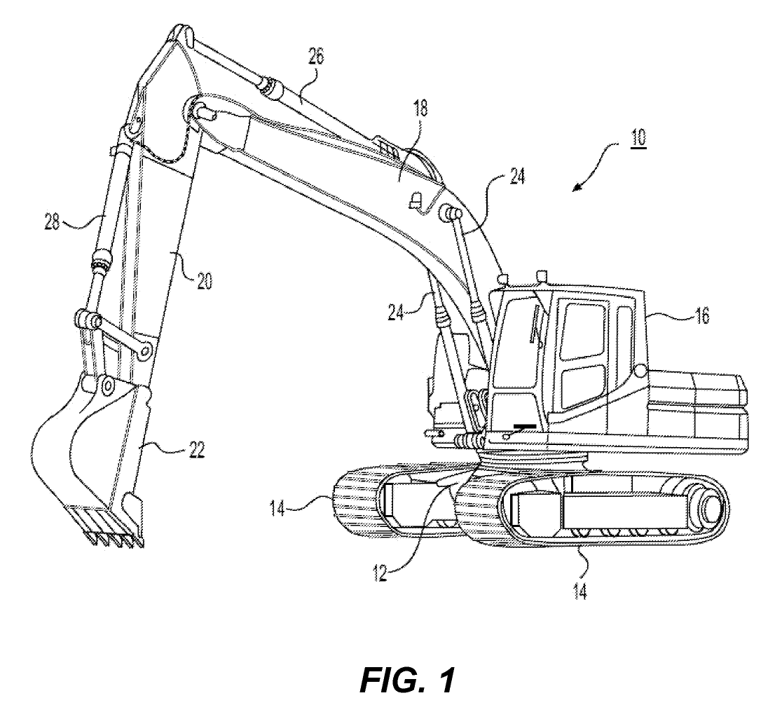

FIG. 1 shows an exemplary embodiment of a machine 10 for performing work. In particular, the exemplary machine 10 shown in FIG. 1 is an excavator for performing operations such as digging and/or loading material. Although the exemplary systems and methods disclosed herein are described in relation to an excavator, the disclosed systems and methods have applications in other machines such as an automobile, truck, agricultural vehicle, wheel loader, dozer, loader, track-type tractor, grader, off-highway truck, or any other machines known to those skilled in the art.

As shown in FIG. 1, exemplary machine 10 includes a chassis 12 flanked by ground-engaging members 14 for moving machine 10 (e.g., via ground-engaging tracks or wheels). Machine 10 includes an operator cab 16 mounted to chassis 12 in a manner that permits rotation of cab 16 with respect to chassis 12. A boom 18 is coupled to cab 16 in a manner that permits boom 18 to pivot with respect to cab 16. At an end opposite cab 16, a stick 20 is coupled to boom 18 in a manner that permits stick 20 to pivot with respect to boom 18. At an end opposite boom 18, an implement 22 (e.g., a digging implement or bucket) is coupled to stick 20 in a manner that permits implement 22 to pivot with respect to stick 20. Although exemplary machine 10 shown in FIG. 1 includes a digging implement, other tools may coupled to stick 20 when other types of work are desired to be performed.

In the exemplary embodiment shown, a pair of actuators 24 is coupled adjacent to cab 16 and boom 18, such that extension and contraction of actuators 24 raises and lowers boom 18, respectively, relative to cab 16. An actuator 26 is coupled to boom 18 and stick 20, such that extension and retraction of actuator 26 results in stick 20 pivoting inward and outward, respectively, with respect to boom 18. Actuator 28 is coupled to stick 20 and digging implement 22, such that extension and retraction of actuator 28 results in digging implement 22 pivoting between closed and open positions, respectively, with respect to stick 20.

Exemplary actuators 24, 26, and 28 are hydraulic devices, in particular, hydraulic cylinders powered by supplying and draining fluid from the cylinders on either side of a piston to cause reciprocating movement of the piston within the cylinder. One or more of actuators 24, 26, and 28 may be non-hydraulic actuators without departing from the concepts disclosed herein. In addition, the number of each of actuators 24, 26, and 28 coupled to boom 18, stick 20, and/or implement 22, respectively, may be changed without departing from the concepts disclosed herein.

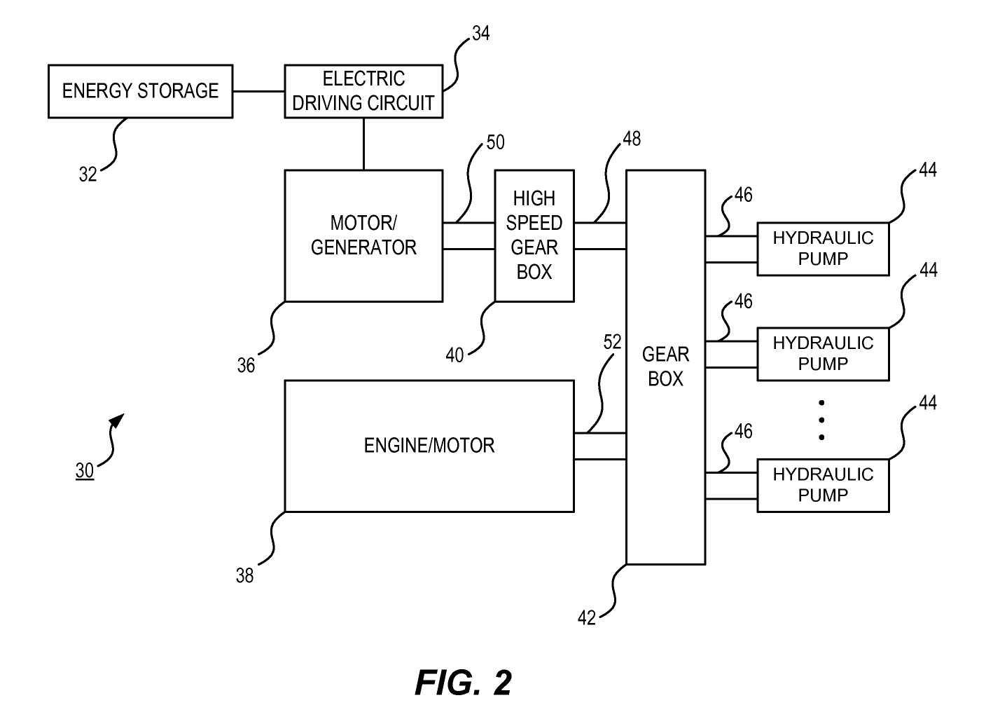

Exemplary actuators 24, 26, and 28 may be driven by one or more hydraulic pumps (e.g., hydraulic pumps 44 in FIG. 2), which are also hydraulic devices that may be coupled to chassis 12, cab 16, boom 18, stick 20, implement 22, and/or actuators 24, 26, and 28. Hydraulic pumps 44 may provide hydraulic power in the form of pressurized fluid flow to actuators 24, 26, and 28 to perform work. During operation of machine 10, one or more hydraulic pumps 44 may output power to, for example, actuator 26 when stick 20 pivots upward with respect to boom 18. On the other hand, when stick 20 pivots downward with respect to boom 18 due to its own weight, the downward action may generate regenerative energy that can be fed back to hydraulic pump(s) 44 in a form of feedback power. The feedback power may be recaptured by a power control system of machine 10, which will be explained in more detail below.

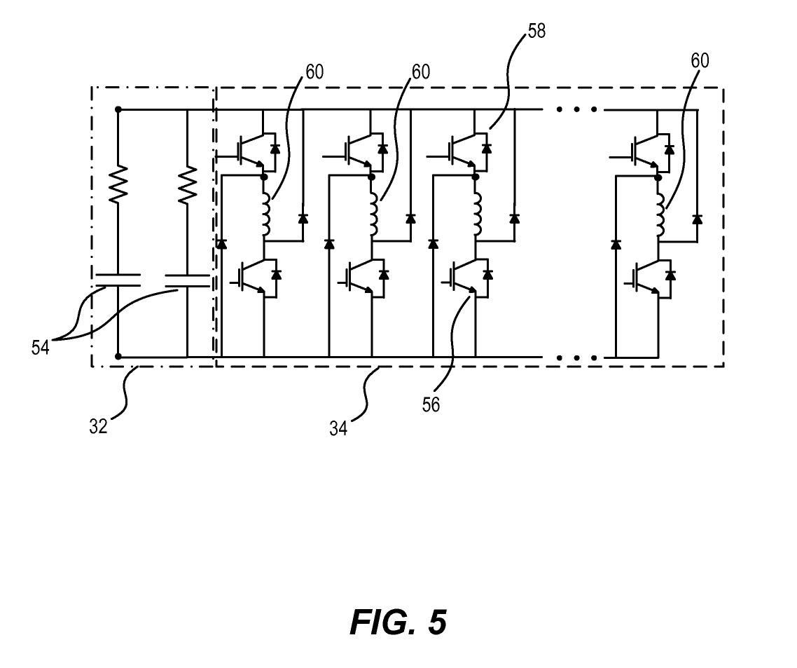

FIG. 2 is a schematic diagram of a first embodiment of the power control system for machine 10. Referring to FIG. 2, power control system 30 includes an energy storage device 32 configured to store electrical energy. For example, energy storage device 32 may include one or more ultra-capacitor devices (e.g., ultra-capacitor devices 54 in FIG. 5). In one embodiment, energy storage device 32 may include a plurality of ultra-capacitor devices connected in parallel, such that the combined capacitance is about the sum of all individual capacitance. The plurality of ultra-capacitor devices connected in parallel may also be referred to as an ultra-capacitor bank. In some embodiments, the capacitance of energy storage device 32 may be at least 10 mF, 100 mF, 1 F, or 5 F. Energy storage device 32 may store and/or release electrical energy rapidly, for example, through charging/discharging ultra-capacitor device(s). In some embodiments, ultra-capacitor devices 54 may include double-layer capacitors with carbon electrodes, pseudocapacitors with metal oxide or conducting polymer electrodes, and/or hybrid capacitors with asymmetric electrodes such as lithium-ion capacitors.

As shown in FIG. 2, power control system 30 also includes an electric motor device 36. Electric motor device 36 may function as a motor to convert electrical power into mechanical power, or may function as a generator to convert mechanical power into electrical power. Electric motor device 36 is coupled to a high speed gearing device 40 (e.g., a high speed gear box). For example, the shaft 50 of electric motor device 36 can be connected to high speed gearing device 40. In some embodiments, the rotating speed of high speed gearing device 40 at the motor side (the side connecting to shaft 50) may be at least 4000 rpm, 5000 rpm, 6000 rpm, 8000 rpm, or 10000 rpm. In some embodiments, electric motor device 36 may include a switch reluctance motor (SRM). An SRM is a type of a stepper motor that runs by reluctance torque. Unlike common direct current (DC) motors, in an SRM power is delivered to the windings in the stator rather than the rotor. This greatly simplifies the mechanical design as power does not have to be delivered to a moving part. An SRM is driven by a chopped DC power having high frequency ON/OFF intervals. Such driving power may be referred to as a high frequency chopped DC power. This driving power can be obtained by chopping an ordinary DC power using high frequency switches (e.g., switches 56, 58 in FIG. 5). In some embodiments, the high frequency chopped DC may have a chopping frequency of at least 1 kHz, 5 kHz, or 10 kHz. In some embodiments, the rotating speed of an SRM may be at least 4000 rpm, 5000 rpm, 6000 rpm, 8000 rpm, or 10000 rpm.

Referring to FIG. 2, power control system 30 also includes an electric driving circuit 34. Electric driving circuit 34 is coupled to electric motor device 36 and energy storage device 32. Electric driving circuit 34 is configured to drive electric motor device 36 using the electrical energy stored in energy storage device 32. For example, referring to FIG. 5, electric driving circuit 34 includes a plurality of switching devices, such as upper switching devices 58 and lower switching devices 56. An upper switching device 58 is coupled between a positive DC line (upper horizontal solid line) and one terminal of a phase coil 60 of electric motor device 36. A lower switching device 56 is coupled between a negative (or ground or neutral) DC line (lower horizontal solid line) and an opposite terminal of phase coil 60. By controlling upper and lower switches to turn on and off in high frequency, phase coil 60 can be connected to or disconnected from DC line, thereby generating a high frequency chopped DC driving power to drive electric motor device 36. Because ultra-capacitor devices 54 are connected between the positive and negative (or ground or neutral) DC lines, electrical power stored in ultra-capacitor devices 54 may be used to drive phase coils 60 through upper/lower switches 58/56, thereby driving electric motor device 36.

Referring back to FIG. 2, electric motor device 36 may be coupled to hydraulic pump 44 through high speed gearing device 40 and a gearing device 42. Gearing device 42 may be a relatively low speed gear box (e.g., lower than the speed of gearing device 40) configured to further decrease the rotational speed in order to match the working rotation speed of hydraulic pump 44. High speed gearing device 40 and gearing device 42 may be coupled through a gearing device coupling 48, such as a shaft, a gear box, or other suitable means. Hydraulic pump 44 may be coupled to gearing device 42 by a hydraulic pump shaft 46. In operation, when hydraulic pump 44 requires power, electric motor device 36 may output power using the electrical energy stored in energy storage device 32. On the other hand, when hydraulic pump 44 feeds back power (mechanical power), the power feedback from hydraulic pump 44 may turn electric motor device 36 into a generator. Once functioning as a generator, electric motor device 36 may convert the mechanical feedback power into electrical power to electrically charge energy storage device 32 through electric drive circuit 34. For example, referring to FIG. 5, in generator mode, phase coil 60 of electric motor device 36 functions as a battery. The power generated from phase coil 60 charges ultra-capacitor devices 54 when both upper and lower switching devices are turned ON, therefore charging energy storage device 32.

Referring back to FIG. 2, power control system 30 may include an engine device 38. Engine device 38 may be, for example, a compression-ignition engine, a spark-ignition engine, a gas turbine engine, a homogeneous-charge compression ignition engine, a two-stroke engine, a four-stroke, or any type of internal combustion engine known to those skilled in the art. Engine device 38 may be configured to operate on any fuel or combination of fuels, such as, for example, diesel, bio-diesel, gasoline, ethanol, methanol, or any fuel known to those skilled in the art. Further, engine device 38 may be supplemented by a hydrogen-powered engine, fuel-cell, solar cell, and/or any power source known to those skilled in the art. In some embodiments, engine device 38 may be an electric engine such as an electric motor device. Engine device 38 is coupled to gearing device 42 through engine device shaft 52 or other suitable means. Engine device 38 may be configured to power hydraulic pump 44. However, in some cases, engine device 38 may not be able to react quickly enough to the power requirement of hydraulic pump 44. For example, when hydraulic pump 44 requires a sudden increase of power output, engine device 38 may be too slow to meet the power requirement. In this case, the power can be compensated by electric motor device 36 using electrical power stored in energy storage device 32. On the other hand, when the power requirement sustained by hydraulic pump 44 suddenly disappears, engine device 38 may not be able to reduce power output rapidly. Therefore, an excess amount of power, indicating a difference between a working power of hydraulic pump 44 and an output power of engine device 28, cannot be consumed by hydraulic pump 44 because the output power is larger than the working power of hydraulic pump 44. In this case, the excess amount of power provided by engine device 38 can be recaptured by electric motor device 36 (e.g., functioning as a generator) to convert the excess amount of power into electrical power and electrically charge energy storage device 32.

In some embodiments, one or more hydraulic pumps 44 may be coupled to gearing device 42, and each individual hydraulic pump may be powered individually. Similarly, each individual hydraulic pump may feed back power to electric motor device 36, which in turn may charge energy storage device 32.

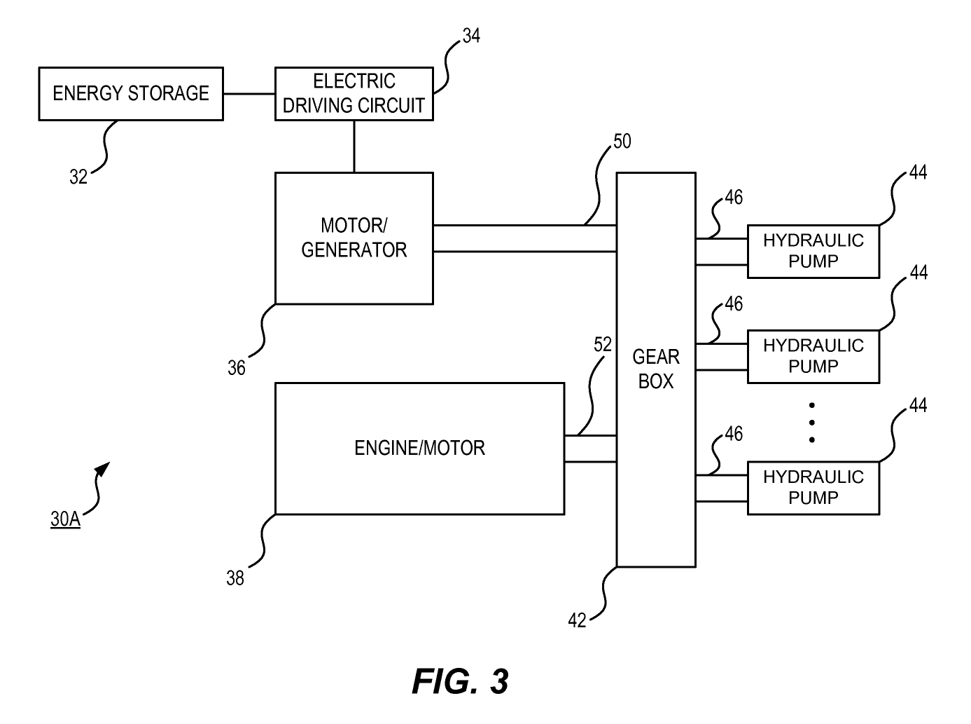

FIG. 3 is a schematic diagram of a second embodiment of the power control system for machine 10. Referring to FIG. 3, power control system 30A includes similar components to those of power control system 30. The difference is that power control system 30A does not include a separate high speed gearing device 40. Instead, both electric motor device 36 and engine device 38 are coupled directly to gearing device 42. In other words, gearing device 42 in FIG. 3 integrates the functionality of high speed gearing device 40 in FIG. 2 such that a separate device is not necessary.

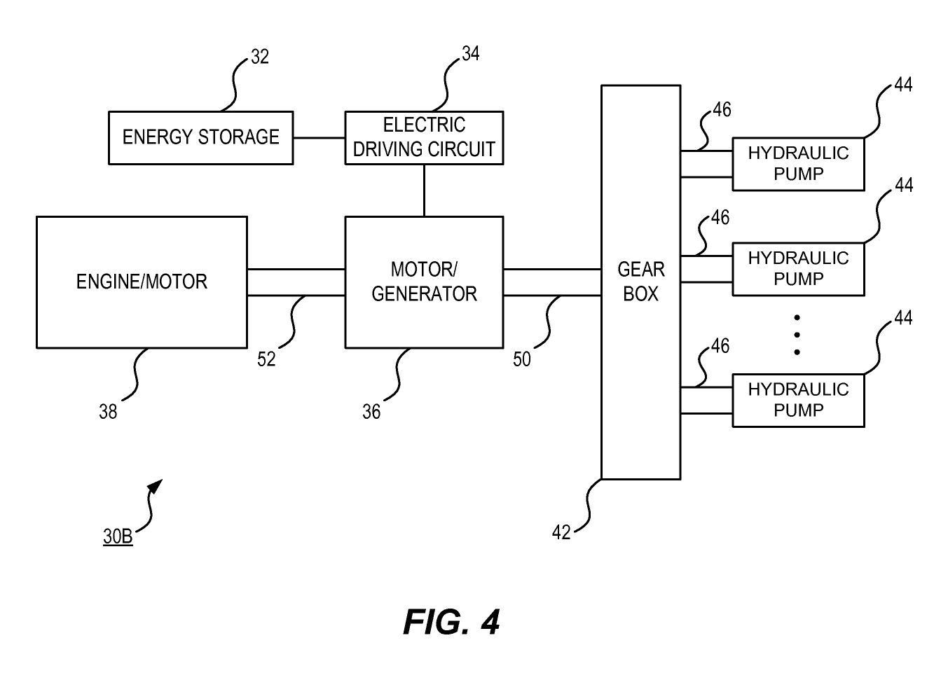

FIG. 4 is a schematic diagram of a third embodiment of the power control system for machine 10. Referring to FIG. 4, power control system 30B includes similar components to those of power control system 30A. The difference is that in FIG. 4, engine device shaft 52 and electric motor device shaft 50 are coaxially coupled together such that the rotating speeds of engine device 38 and electric motor device 36 would stay the same during operation. In this case, engine device 38 may be an electric motor to match the rotating speed of electric motor device 36. Alternatively, electric motor device 36 may have a rotating speed matching the rotating speed of engine device 38. For example, electric motor device 36 may be a permanent magnet motor or induction motor.

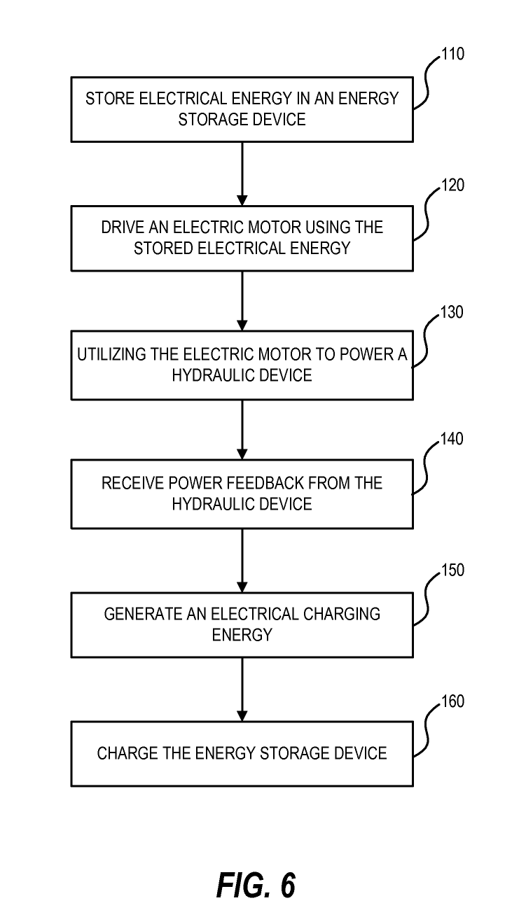

FIG. 6 shows a flow diagram of an exemplary embodiment of a method for controlling power in exemplary machine 10. As shown in FIG. 6, exemplary method begins at step 110 with storage of electrical energy in energy storage device 32. At step 120, electric driving circuit 34 may drive electric motor device 36 using the stored electrical energy in the energy storage device 32. For example, electric driving circuit 34 may drive electric motor device 36 through the plurality of switching devices shown in FIG. 5. At step 130, electric motor device 36 may be used to power a hydraulic device, such as hydraulic pump 44. For example, electric motor device 36 may convert electrical power into mechanical power and output to hydraulic pump 44 through gearing device 42. At step 140, power feedback from hydraulic pump 44 may be received, for example, when stick 20 pivots downward due to its own weight thus causing a regenerative power to be generated and received by electric motor device 36. At step 150, electric motor device 36 may function as a generator to generate an electrical charging energy from the feedback power received from hydraulic pump 44. At step 160, electric motor device 36 may charge energy storage device 32 through electric driving circuit 34. For example, electric driving circuit may convert the electrical charge energy from a high frequency chopped DC power into a DC power through the operation of switching devices.

### INDUSTRIAL APPLICABILITY

Exemplary machine 10 may be used for performing many types of work. Exemplary machine 10 shown in FIG. 1 is an excavator for performing operations such as digging and/or loading material. Although the exemplary systems and methods disclosed herein are described in relation to an excavator, the disclosed systems and methods have applications in other machines such as an automobile, truck, agricultural vehicle, wheel loader, dozer, loader, track-type tractor, grader, off-highway truck, or any other machines known to those skilled in the art.

Exemplary power control systems in machine 10 may be used to control power in a machine having hydraulic devices that may act as either power suppliers or consumers. In particular, exemplary power control systems control the power supply and consumption of the hydraulic devices in a manner that improves the efficiency of a machine, while maintaining desirable control characteristics of the machine.

Several advantages over the prior art may be associated with the power control system. First, a separate DC/DC converter to charge/discharge the ultra-capacitor bank may be eliminated, reducing the overall system cost. Second, use of SRM improves system efficiency. Third, only one engine device is needed, instead of two, because the peak power requirement can be compensated with electrical power. Elimination of one engine device reduces the size, cost, and footprint of the machine. Fourth, rapid response to sudden load increase/decrease enhances system performance. Fifth, regenerative energy can be effectively recaptured, thus reducing energy consumption.

It will be apparent to those skilled in the art that various modifications and variations can be made to the power control system. Other embodiments will be apparent to those skilled in the art from consideration of the specification and practice of the disclosed power control system. It is intended that the specification and examples be considered as exemplary only, with a true scope being indicated by the following claims and their equivalents.

What is claimed is:

1. A power control system for a machine, comprising:
an electric motor device configured to power a hydraulic device;
an energy storage device configured to store electrical energy; and
an electric driving circuit coupled to the electric motor device and the energy storage device, the electric driving circuit being configured to drive the electric motor device using the electrical energy stored in the energy storage device;
wherein the electric motor device is configured to function as a generator to receive power feedback from the hydraulic device and electrically charge the energy storage device through the electric driving circuit.

2. The power control system of claim 1, further including an engine device configured to power the hydraulic device, wherein the electric motor device is configured to receive an excess amount of power provided by the engine device to electrically charge the energy storage device, the excess amount of power indicating a difference between a working power of the hydraulic device and an output power of the engine device.

3. The power control system of claim 2,
wherein the engine device is coupled to the hydraulic device through a first gearing device; and
wherein the electric motor device is coupled to the hydraulic device through the first gearing device and a second gearing device, the second gearing device having a higher speed than the first gearing device.

4. The power control system of claim 2, wherein both the engine device and the electric motor device are coupled to the hydraulic device through a gearing device.

5. The power control system of claim 2, wherein the engine device is coaxially coupled to the electric motor device.

6. The power control system of claim 1, wherein the electric driving circuit includes a plurality of switching devices, each switching device being coupled to a phase coil of the electric motor device.

7. The power control system of claim 1, wherein the energy storage device includes an ultra-capacitor device.

8. The power control system of claim 1, wherein the energy storage device has a capacitance of at least 100 mF.

9. The power control system of claim 1, wherein the electric motor device includes a switch reluctance motor (SRM).

10. The power control system of claim 9, wherein the electric driving circuit is configured to convert the electrical energy stored in the energy storage device from a direct current (DC) into a high frequency chopped DC to drive the SRM.

11. The power control system of claim 10, wherein the high frequency chopped DC has a chopping frequency of at least 1 kHz.

12. A method of controlling power for a machine, comprising:
storing electrical energy in an energy storage device;
utilizing an electric driving circuit to drive an electric motor device using the stored electrical energy;
utilizing the electric motor device to power a hydraulic device;
receiving power feedback from the hydraulic device;
utilizing the electric motor device to generate an electrical charging energy using the power feedback from the hydraulic device; and
utilizing the electric driving circuit to charge the energy storage device using the electrical charging energy.

13. The method of claim 12, further including:
receiving an excess amount of power provided by an engine device configured to power the hydraulic device, the excess amount of power indicating a difference between a working power of the hydraulic device and an output power of the engine device; and
charging the energy storage device using the excess amount of power.

14. The method of claim 12, wherein storing the electrical energy includes storing the electrical energy in an ultra-capacitor device.

15. The method of claim 12, wherein utilizing the electric driving circuit to drive the electric motor device includes converting the electrical energy stored in the energy storage device from a direct current (DC) into a high frequency chopped DC.

16. The method of claim 12, wherein utilizing the electric driving circuit to charge the energy storage device includes converting the electrical charging energy from a high frequency chopped direct current (DC) into a DC.

17. A machine including a work tool comprising:
a chassis;
a hydraulic device configured to cause a movement of the work tool;
an electric motor device configured to power the hydraulic device;
an energy storage device configured to store electrical energy; and
an electric driving circuit coupled to the electric motor device and the energy storage device, the electric driving circuit being configured to drive the electric motor device using the electrical energy stored in the energy storage device;
wherein the electric motor device is configured to function as a generator to receive power feedback from the hydraulic device and electrically charge the energy storage device through the electric driving circuit.

18. The machine of claim 17, further including an engine device configured to power the hydraulic device, wherein the electric motor device is configured to receive an excess amount of power provided by the engine device to electrically charge the energy storage device, the excess amount of power indicating a difference between a working power of the hydraulic device and an output power of the engine device.

19. The machine of claim 17, wherein the energy storage device includes an ultra-capacitor device.

20. The machine of claim 17, wherein the electric motor device includes a switch reluctance motor (SRM).
